(19) United States
(12) Patent Application Publication
(10) Pub. No.: US 2010/0138106 A1
(43) Pub. Date: Jun. 3, 2010

(54) METHOD TO IGNORE ODOMETER ACCUMULATION WHILE IN PTO MODE

(76) Inventors: William W. Bowen, Brownstown, MI (US); Marleen F. Thompson, Mount Clemens, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/325,393

(22) Filed: Dec. 1, 2008

(51) Int. Cl. G06F 7/00

(52) U.S. Cl. 701/35; 701/29

(57) ABSTRACT

A method to operate a vehicle having a parking brake, an odometer, and a powertrain including an engine with an electronic control unit in communication with a transmission.

### TECHNICAL FIELD

Operation of a heavy duty diesel vehicle is an expensive proposition. Numerous taxes, fees and other costs add to high fuel costs to pressure margins. Operators and owners may accumulate costs even thought the vehicle is not moving or carrying freight. This results in inefficient business practices that can raise costs unacceptably.

One area where such fees are assessed is when a vehicle is operating but not in motion. For example, when a vehicle is operating but the parking brake is set, it is still possible to incur costs and government fees because such fees are assessed based upon odometer readings. Odometer readings can be accumulated even when the vehicle is not moving. This results in unnecessary fees when income is not being generated by the vehicle operator or owner.

One area for improvement is to permit the vehicle to operate without accumulating odometer readings, but to accumulate such odometer readings only when the vehicle is in motion.

### BRIEF SUMMARY OF THE INVENTION

In one embodiment, there is disclosed a method to operate a vehicle having a parking brake, an odometer, and a powertrain including an engine with an electronic control unit in communication with a transmission, comprising:

determining whether said vehicle is operating in power take off mode;

determining whether said parking brake is engaged, and

disengaging an odometer accumulation function.

The method may further include sensing vehicle speed and logging odometer time. The Power Take Off mode may be determined by output of the transmission. When the vehicle speed is zero and said parking brake is set, the electronic control unit ceases odometer accumulation time, and stores such event in memory thereby reducing taxes paid based upon said odometer.

In another embodiment, there is disclosed a method to reduce taxes paid on vehicle operation, said vehicle including a parking brake, an odometer, an engine with an electronic control unit with memory in communication with said parking brake and the odometer, and a transmission. The method comprises:

determining whether said vehicle is operating in power take off mode;

determining whether said parking brake is engaged disengaging said odometer accumulation;

logging said event in memory of electronic control unit for download.

The power take off mode may be determined by output from said transmission.

### BRIEF DESCRIPTION OF THE DRAWINGS

FIG. 1 is a schematic representation of an electronically controlled internal combustion engine system;

FIG. 2 is a schematic representation of a software flow chart showing one embodiment of the method to ignore odometer accumulation while the vehicle is in PTO mode.

### DETAILED DESCRIPTION OF THE INVENTION

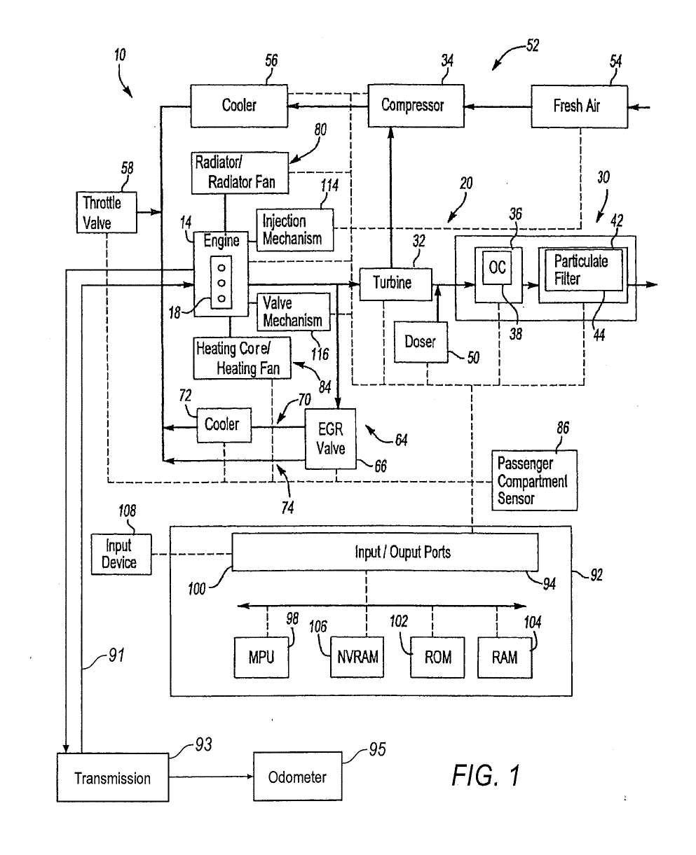

FIG. 1 illustrates a vehicle powertrain system 10 in accordance with one non-limiting aspect of the present invention. The system 10 may provide power for driving any number of vehicles, including on-highway trucks, construction equipment, marine vessels, stationary generators, automobiles, trucks, tractor-trailers, boats, recreational vehicle, light and heavy-duty work vehicles, and the like.

The system 10 may be referred to as an internal combustion driven system wherein fuels, such as gasoline and diesel fuels, are burned in a combustion process to provide power, such as with a spark or compression ignition engine 14. The engine 14 may be a diesel engine that includes a number of cylinders 18 into which fuel and air are injected for ignition as one skilled in the art will appreciate. The engine 14 may be a multi-cylinder compression ignition internal combustion engine, such as a 4, 6, 8, 12, 16, or 24 cylinder diesel engines, for example. It should be noted, however, that the present invention is not limited to a particular type of engine or fuel.

Exhaust gases generated by the engine 14 during combustion may be emitted through an exhaust system 20. The exhaust system 20 may include any number of features, including an exhaust manifold and passageways to deliver the emitted exhaust gases to a particulate filter assembly 30, which in the case of diesel engines is commonly referred to as a diesel particulate filter. Optionally, the system 20 may include a turbocharger proximate the exhaust manifold for compressing fresh air delivery into the engine 14. The turbocharger, for example, may include a turbine 32 and a compressor 34, such as a variable geometry turbocharger (VGT) and/or a turbo compound power turbine. Of course, the present invention is not limited to exhaust systems having turbochargers or the like.

The particulate filter assembly 30 may be configured to capture particulates associated with the combustion process. In more detail, the particulate filter assembly 30 may include an oxidation catalyst (OC) canister 36, which in includes an OC 38, and a particulate filter canister 42, which includes a particulate filter 44. The canisters 36, 42 may be separate components joined together with a clamp or other feature such that the canisters 36, 42 may be separated for servicing and other operations. Of course, the present invention is not intended to be limited to this exemplary configuration for the particulate filter assembly 30. Rather, the present invention contemplates the particulate filter assembly including more or less of these components and features. In particular, the present invention contemplates the particulate filter assembly 30 including only the particulate filter 44 and not necessarily the OC canister 36 or substrate 38 and that the particulate filter 44 may be located in other portions of the exhaust system 20, such as upstream of the turbine 32.

The OC 38, which for diesel engines is commonly referred to as a diesel oxidation catalyst, may oxidize hydrocarbons and carbon monoxide included within the exhaust gases so as to increase temperatures at the particulate filter 44. The particulate filter 44 may capture particulates included within the exhaust gases, such as carbon, oil particles, ash, and the like, and regenerate the captured particulates if temperatures associated therewith are sufficiently high. In accordance with one non-limiting aspect of the present invention, one object of the particulate filter assembly 30 is to capture harmful carbonaceous particles included in the exhaust gases and to store these contaminates until temperatures at the particulate filter 44 favor oxidation of the captured particulates into a gas that can be discharged to the atmosphere.

The OC and particulate filter canisters 36, 42 may include inlets and outlets having defined cross-sectional areas with expansive portions there between to store the OC 38 and particulate filter 44, respectively. However, the present invention contemplates that the canisters 36, 42 and devices therein may include any number configurations and arrangements for oxidizing emissions and capturing particulates. As such, the present invention is not intended to be limited to any particular configuration for the particulate filter assembly 30.

To facilitate oxidizing the capture particulates, a doser 50 may be included to introduce fuel to the exhaust gases such that the fuel reacts with the OC 38 and combusts to increase temperatures at the particulate filter 44, such as to facilitate regeneration. For example, one non-limiting aspect of the present invention contemplates controlling the amount of fuel injected from the doser as a function of temperatures at the particulate filter 44 and other system parameters, such as air mass flow, EGR temperatures, and the like, so as to control regeneration. However, the present invention also contemplates that fuel may be included within the exhaust gases through other measures, such as by controlling the engine 14 to emit fuel with the exhaust gases.

An air intake system 52 may be included for delivering fresh air from a fresh air inlet 54 through an air passage to an intake manifold for introduction to the engine 14. In addition, the system 52 may include an air cooler or charge air cooler 56 to cool the fresh air after it is compressed by the compressor 34. Optionally, a throttle intake valve 58 may be provided to control the flow of fresh air to the engine 14. Optionally, the throttle intake valve 58 may also be provided to control the flow of EGR gases to the engine 14 or control both fresh air and EGR gases 64 to the engine 14. The throttle valve 58 may be a manually or electrically operated valve, such as one which is responsive to a pedal position of a throttle pedal operated by a driver of the vehicle. There are many variations possible for such an air intake system and the present invention is not intended to be limited to any particular arrangement. Rather, the present invention contemplates any number of features and devices for providing fresh air to the intake manifold and cylinders, including more or less of the foregoing features.

An exhaust gas recirculation (EGR) system 64 may be optionally provided to recycle exhaust gas to the engine 14 for mixture with the fresh air. The EGR system 64 may selectively introduce a metered portion of the exhaust gasses into the engine 14. The EGR system 64, for example, may dilute the incoming air charge and lower peak combustion temperatures to reduce the amount of oxides of nitrogen produced during combustion. The amount of exhaust gas to be re-circulated may be controlled by controlling an EGR valve 66 and/or in combination with other features, such as the turbocharger. The EGR valve 66 may be a variable flow valve that is electronically controlled. There are many possible configurations for the controllable EGR valve 66 and embodiments of the present invention are not limited to any particular structure for the EGR valve 66.

The EGR system 64 in one non-limiting aspect of the present invention may include an EGR cooler passage 70, which includes an EGR cooler 72, and an EGR cooler bypass 74. The EGR valve 66 may be provided at the exhaust manifold to meter exhaust gas through one or both of the EGR cooler passage 70 and bypass 74. Of course, the present invention contemplates that the EGR system 64 may include more or less of these features and other features for recycling exhaust gas. Accordingly, the present invention is not intended to be limited to any one EGR system and contemplates the use of other such systems, including more or less of these features, such as an EGR system having only one of the EGR cooler passage or bypass.

A cooling system 80 may be included for cycling the engine 14 by cycling coolant there through. The coolant may be sufficient for fluidly conducting away heat generated by the engine 14, such as through a radiator. The radiator may include a number of fins through which the coolant flows to be cooled by air flow through an engine housing and/or generated by a radiator fan directed thereto as one skilled in the art will appreciated. It is contemplated, however, that the present invention may include more or less of these features in the cooling system 80 and the present invention is not intended to be limited to the exemplary cooling system described above. The cooling system 80 may operate in conjunction with a heating system 84. The heating system 84 may include a heating core, a heating fan, and a heater valve. The heating core may receive heated coolant fluid from the engine 14 through the heater valve so that the heating fan, which may be electrically controllable by occupants in a passenger area or cab of a vehicle, may blow air warmed by the heating core to the passengers. For example, the heating fan may be controllable at various speeds to control an amount of warmed air blown past the heating core whereby the warmed air may then be distributed through a venting system to the occupants. Optionally, sensors and switches 86 may be included in the passenger area to control the heating demands of the occupants. The switches and sensors may include dial or digital switches for requesting heating and sensors for determining whether the requested heating demand was met. The present invention contemplates that more or less of these features may be included in the heating system and is not intended to be limited to the exemplary heating system described above.

A controller 92, such as an electronic control module or engine control module, may be included in the system 10 to control various operations of the engine 14 and other system or subsystems associated therewith, such as the sensors in the exhaust, EGR, and intake systems. Various sensors may be in electrical communication with the controller via input/output ports 94. The controller 92 may include a microprocessor unit (MPU) 98 in communication with various computer readable storage media via a data and control bus 100. The computer readable storage media may include any of a number of known devices which function as read only memory 102, random access memory 104, and non-volatile random access memory 106. A data, diagnostics, and programming input and output device 108 may also be selectively connected to the controller via a plug to exchange various information therebetween. The device 108 may be used to change values within the computer readable storage media, such as configuration settings, calibration variables, instructions for EGR, intake, and exhaust systems control and others.

The controller 92 is in electronic communication with a transmission 93 via a CAN 91. The transmission has a CPU that controls the operation of the transmission in conformity to requests from the engine controller 92 in a manner well known to those of skill in the art. The odometer 95 receives input from, among other components, the transmission to accurately measure the miles traveled in the manner well known to those skilled in the art.

The system 10 may include an injection mechanism 114 for controlling fuel and/or air injection for the cylinders 18. The injection mechanism 114 may be controlled by the controller 92 or other controller and comprise any number of features, including features for injecting fuel and/or air into a common-rail cylinder intake and a unit that injects fuel and/or air into each cylinder individually. For example, the injection mechanism 114 may separately and independently control the fuel and/or air injected into each cylinder such that each cylinder may be separately and independently controlled to receive varying amounts of fuel and/or air or no fuel and/or air at all. Of course, the present invention contemplates that the injection mechanism 114 may include more or less of these features and is not intended to be limited to the features described above.

The system 10 may include a valve mechanism 116 for controlling valve timing of the cylinders 18, such as to control air flow into and exhaust flow out of the cylinders 18. The valve mechanism 116 may be controlled by the controller 92 or other controller and comprise any number of features, including features for selectively and independently opening and closing cylinder intake and/or exhaust valves. For example, the valve mechanism 116 may independently control the exhaust valve timing of each cylinder such that the exhaust and/or intake valves may be independently opened and closed at controllable intervals, such as with a compression brake. Of course, the present invention contemplates that the valve mechanism may include more or less of these features and is not intended to be limited to the features described above.

In operation, the controller 92 receives signals from various engine/vehicle sensors and executes control logic embedded in hardware and/or software to control the system 10. The computer readable storage media may, for example, include instructions stored thereon that are executable by the controller 92 to perform methods of controlling all features and sub-systems in the system 10. The program instructions may be executed by the controller in the MPU 98 to control the various systems and subsystems of the engine and/or vehicle through the input/output ports 94. In general, the dashed lines shown in FIG. 1 illustrate the optional sensing and control communication between the controller and the various components in the powertrain system. Furthermore, it is appreciated that any number of sensors and features may be associated with each feature in the system for monitoring and controlling the operation thereof.

In one non-limiting aspect of the present invention, the controller 92 may be the DDEC controller available from Detroit Diesel Corporation, Detroit, Mich. Various other features of this controller are described in detail in a number of U.S. patents assigned to Detroit Diesel Corporation. Further, the controller may include any of a number of programming and processing techniques or strategies to control any feature in the system 10. Moreover, the present invention contemplates that the system may include more than one controller, such as separate controllers for controlling system or sub-systems, including an exhaust system controller to control exhaust gas temperatures, mass flow rates, and other features associated therewith. In addition, these controllers may include other controllers besides the DDEC controller described above.

In accordance with one non-limiting aspect of the present invention, the controller 92 or other feature, may be configured for permanently storing emission related fault codes in memory that is not accessible to unauthorized service tools. Authorized service tools may be given access by a password and in the event access is given, a log is made of the event as well as whether any changes that are attempted to made to the stored fault codes. It is contemplated that any number of faults may be stored in permanent memory, and that preferably eight such faults are stored in memory.

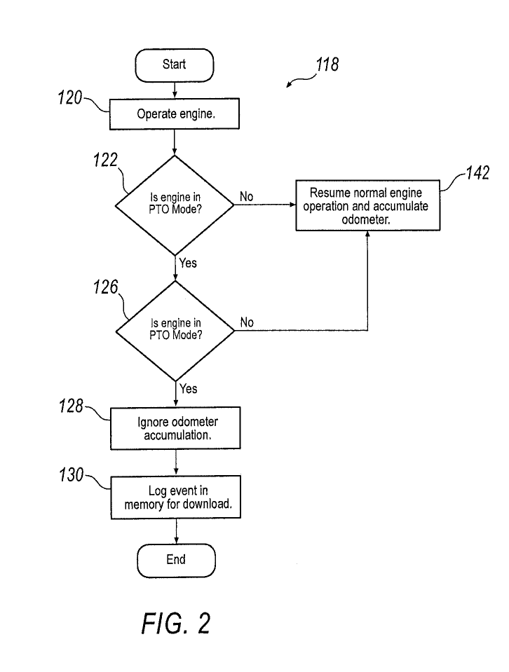

FIG. 2 is a schematic representation of a software flow chart showing of method 118 of ignoring the odometer according to one disclosed embodiment. of the disclosure.

Specifically, step 120 is operating the engine. When the engine is operating, step 122 is determining whether the engine is in Power Take Off (PTO) mode. In one embodiment, Power Take Off mode may be determined by measuring the output of the transmission.

If no, step 142 is resume normal operation of the vehicle and accumulation of the odometer. If the determination in step 120 is yes, the vehicle is in PTO mode, step 126 is determine whether the parking brake is engaged. If no, step the software loops to step 142. If yes, step 128 is ignore the odometer accumulation. When the parking brake is set, vehicle speed is zero and the electronic control unit ceases odometer accumulation time, and stores such event in memory therein residing taxes paid based upon said odometer.

The method continues to step 130 wherein the event is logged in memory for download by the vehicle owner.

The words used in the specification are words of description, not words of limitation. Many modifications and variations are apparent to those of ordinary skill in the art without departing from the scope and spirit of the invention as set forth in the appended claims.

What is claimed as new and desired to be protected by Letters Patent of the United States is:

1. A method to operate a vehicle having a parking brake, an odometer, and a powertrain including an engine with an electronic control unit in communication with a transmission, comprising:
determining whether said vehicle is operating in power take off mode;
determining whether said parking brake is engaged, and
disengaging an odometer accumulation function.

2. The method of claim 1 wherein said odometer accumulation includes sensing vehicle speed and logging odometer time.

3. The method of claim 1, wherein said power take off mode is determined by output of the transmission.

4. The method of claim 1, wherein when said vehicle speed is zero and said parking brake is set, the electronic control unit ceases odometer accumulation time, and stores such event in memory therein residing taxes paid based upon said odometer.

5. A method to reduce taxes paid on vehicle operation, said vehicle including a parking brake, an odometer, an engine with an electronic control unit with memory in communication with said parking brake and said odometer, and a transmission, said method comprising:
determining whether said vehicle is operating in power take off mode;
determining whether said parking brake is engaged disengaging said odometer accumulation;
logging said event in memory of electronic control unit for download.

6. The method of claim 5, wherein power take off mode is determined by output from said transmission.
